(19) United States
(12) Patent Application Publication
(10) Pub. No.: US 2006/0155543 A1
(43) Pub. Date: Jul. 13, 2006

(54) Dynamic voice allocation in a vector processor based audio processor

(75) Inventor: John S. Cooper, El Sobrante, CA (US)

Correspondence Address: HAYNES BEFFEL & WOLFELD LLP, P O BOX 366, HALF MOON BAY, CA, 94019, US

(73) Assignee: KORG, INC., INAGI-CITY (JP)

(21) Appl. No.: 11/187,070

(22) Filed: Jul. 22, 2005

Related U.S. Application Data
(60) Provisional application No. 60/643,532, filed on Jan. 13, 2005.

(51) Int. Cl. G10L 13/02

(52) U.S. Cl. 704/261

(57) ABSTRACT

A method dynamically allocating voices to processor resources in a music synthesizer or other audio processor includes utilizing processor resources to execute vector-based voice generation algorithm for sounding voices, such as executed using SIMD architecture processors or other vector processor architectures. The dynamic voice allocation process identifies a new voice to be executed in response to an event. The combined processor resources needed to be allocated for the new voice and for the currently sounding voices are determined. If the processor resources are available to meet the combined need, then processor resources are allocated to a voice generation algorithm for the new voice, and if the processor resources are not available, then voices are stolen. To steal voices, processor resources are de-allocated from at least one sounding voice or sounding voice cluster.

The present application claims the benefit of U.S. Provisional Application No. 60/643,532 filed 13 Jan. 2005.

### BACKGROUND OF THE INVENTION

1. Field of the Invention

The present invention relates to music synthesizers that use general purpose processors to execute multiple voice generation algorithms in which each algorithm simultaneously calculates multiple voices using vector processing, and in particular to methods of dynamic voice allocation and resource allocation in such a music synthesizer.

2. Description of Related Art

The use of general purpose CPUs or DSPs to execute sound generating programs that produce musical tones in response to user input is well known in the music synthesizer industry. The use of general purpose CPUs or DSPs that include parallel instruction sets to compute multiple waveforms in parallel is also well known. In typical software synthesizers there is a sample rate clock and a frame rate clock that is some multiple, N, (e.g. 16, 32, 64, 128) of the sample rate clock. Each frame, the code runs and an audio buffer of N audio samples is filled. These samples are then read out of the buffer and output as sound in the next frame period. If the buffer cannot be filled completely by the time it is read out (e.g. because the CPU did not have enough time to execute all of the code needed to fill the buffer) an error occurs in the output waveform due to the incomplete buffer. Many software synthesizers deal with this problem poorly, or not at all. For example, in many software synthesis systems, the user must be careful not to play “too many notes” or else they will hear a “click” or “pop” in the audio when the output buffer could not be filled in time. To handle this problem, a robust method for voice allocation and resource management is needed.

Dynamic voice allocation in an electronic musical instrument implies the ability to activate an arbitrary sound using whatever sound generation resources (e.g. memory, processors, bus cycles, etc.) are required, regardless of whether or not the resources are currently available. This means that if resources are available, they are used immediately, and if resources are not available, they must be “stolen” from whatever voice (or other process) that is currently using them and reallocated to the new voice. In addition, the voice allocator must manage existing and new voices so that the limits of processing resources and memory are not exceeded.

U.S. Pat. No. 5,981,860, entitled “Sound Source System Based on Computer Software and Method of Generating Acoustic Waveform Data,” describes a software synthesizer based on a general purpose CPU with a simple voice allocation mechanism. In response to a note-on event, voices are initialized and prepared for computation immediately with no regard to cost impact. Each processing frame, the load of the CPU is checked to determine how many voices can be computed within that frame. If the requested number of voices is more than can be computed, some voices are muted during the current frame. No method is described for prioritizing which voices are muted. In another embodiment of U.S. Pat. No. 5,981,860, the sample rate is lowered or a simpler algorithm is substituted when the CPU load is too high to complete all of the required computation. All of these methods result in lower fidelity and lower sound quality.

Another software synthesizer is described in “Software Sound Source,” U.S. Pat. No. 5,955,691. The software synthesizer is based on a general purpose CPU using vector processing to compute multiple voices in parallel. The implications of vector processing for voice allocation and resource management are not discussed. There is no provision in that invention for handling the case when more voices are requested than can be computed within one frame.

U.S. Pat. No. 5,376,752 entitled “Open Architecture Synthesizer with Dynamic Voice Allocation,” describes a software synthesizer and a system for dynamic voice allocation. The system described is very specific to that synthesizer's particular architecture. However, it does describe the basics of allocating new resources given fixed limits of memory and CPU processing, and the basics of voice stealing with voice ramp-down (see FIGS. 14-17 in U.S. Pat. No. 5,376,752). It does not describe vector processing and the implications for voice allocation. Also, it does not discuss the method of determining the cost of an event (other than number of voices required), nor hierarchical prioritization of stolen voices, nor stagger starting to avoid excessive cost impact within any single frame.

In a real time system, basically all of the computation required for the various voice models and effects algorithms used for sounding data in each frame must be completed in that frame. If the total computational load is too large to be completed in one frame, then the task must be reduced in size to ensure that it can be completed in time. A method is needed to allocate data processing resources among all of the various voice models and effects algorithms in real time systems to ensure that the synthesized output sounds good, without glitches caused by failing to meet the frame-to-frame timing.

### SUMMARY OF THE INVENTION

A flexible, dynamic resource allocation method and system for audio processing systems are described.

A method is described herein for dynamically allocating voices to processor resources in a music synthesizer or other audio processor, while executing a plurality of currently executing voices. The method includes utilizing processor resources to execute voice generation algorithms for sounding voices. In a described embodiment, the voice generation algorithms comprise vector-based voice generation algorithms, such as executed using SIMD architecture processors or other vector processor architectures. An instance of an allocated vector-based voice generation algorithm is configurable to generate N voices, where N is an integer greater than one. The dynamic voice allocation process identifies a new voice, or new cluster of voices, to be executed in response to an event, such as a note-on event caused by pressing a key on a keyboard of a synthesizer. The combined processor resources needed to be allocated for the new voice, or new cluster, and for the currently sounding voices are determined. If the processor resources are available to meet the combined need, then processor resources are allocated to a voice generation algorithm for the new voice, or new cluster of voices, and if the processor resource are not available, then voices are stolen. To steal voices, processor resources are de-allocated from at least one sounding voice or sounding voice cluster. In embodiments described herein, the voice allocation process iterates until the new voice or new cluster is successfully allocated.

In embodiments of the voice allocator, the process for determining the processor resources needed includes resolving whether the new voice or a new voice within a new cluster, can be generated by an already allocated instance of a vector-based voice generation algorithm. For example, if an allocated instance of a vector-based voice generation algorithm is currently only partially full, executing fewer than N vectors, then a free vector within the allocated instance can be used for the new voice. In embodiments in which the processor resources execute a plurality of instances of a particular voice-based voice generation algorithm, where each instance is configurable to execute N voices, the dynamic voice allocator defragments the processor resources by reconfiguring the plurality of instances of the vector-based voice generation algorithm after freeing voices, so that at most one of the plurality of instances is configured to execute less than N voices.

The voice allocator in an example described herein maintains a start queue and a delay queue for voices or clusters of voices. Upon allocating a new voice or new cluster to processor resources, the new voice or cluster is added to the start queue. If however processor resources are not available at the note-on event, then the new voice or cluster is added to the delay queue. New voices or new clusters are moved out of the delay queue into the start queue after a delay which is adapted to allow the voice stealing process to free sufficient processor resources.

A dynamic voice allocator described herein assigns a resources cost parameter to voices and to effects to which processor resources can be allocated, and assigns a maximum processor resources parameter that provides an indication of risk of system overage, in which underruns or other glitches might occur. The dynamic voice allocator also computes an allocated processor resources parameter indicating the amount of processor resources being used by allocated voices and effects. Upon identification of a new voice to be started, the dynamic voice allocator determines whether processor resources are available for the new voice by determining whether a combination of the allocated processor resources parameter with the resources cost parameter for the new voice, or new cluster of Voices, exceeds the maximum processor resources parameter. If the maximum processor resources parameter is exceeded, then the dynamic voice allocator steals sounding voices to free resources.

In embodiments described herein, the maximum processor resources parameter is changed in response to a measure of allocation of processor resources. For example, if the measure of allocation of processor resources indicates that greater than a threshold of resources are being used, then the maximum processor resources parameter can be reduced temporarily to avoid system overages.

An embodiment is described herein in which the maximum processor resources parameter is also used as a measure of the cost of the newly allocated cluster of voices. If the newly allocated voice cluster has a resources cost parameter that exceeds the maximum processor resources parameter, then the newly allocated cluster can be trimmed.

An audio processor is described which includes a data processor and resources to execute the method discussed above. Also, an article of manufacture comprising computer programs stored on machine-readable media is described, where the computer programs can be used to execute the processes described above.

Using a dynamic voice allocator, the system measures or estimates the cost of each effect and each voice and the sum of all the costs is kept under the limit required for real time performance. When no effects are loaded, all available processor resources can be used for voice models. When effects are added, the processor resources available to the voice models are decreased by the cost of the effects resources.

Voice stealing is necessary whenever a new voice or effect is requested that would cause the total to exceed the real time limit. Adding a new effect or voice may require stealing more than one voice if algorithms are different sizes.

Dynamic resource management allows the user to activate an arbitrary sound regardless of whether or not the required resources for playing the sound are currently available. Flexible allocation between effects and voices allows a greater portion of the data processor resources to be used for computation of voices when the effects are not fully utilized. Dynamic allocation of resources techniques are described which are able to allocate resources to one type of voice model (like PCM) that are freed by stealing a voice executing a different voice model (like analog), based on evaluation of the use of processor resources. Techniques described herein are applicable to voice generation algorithms that vector based and well as voice generation algorithms that are not vector based.

Other aspects and advantages of the present invention can be seen on review of the drawings, the detailed description and the claims, which follow.

### BRIEF DESCRIPTION OF THE DRAWINGS

FIG. 1 is a simplified diagram of a synthesis system using a vector processor, and including logic implementing procedures for dynamic voice allocation.

FIG. 2 schematically illustrates vector processor based voice models executed in a system like that of FIG. 1.

FIG. 3 illustrates a data structure for managing dynamic voice allocation for vector based voice models.

FIG. 4 schematically illustrates lists of voices organized for dynamic voice allocation for systems as described herein.

FIG. 5 shows a simplified flow chart of a basic run engine with dynamic voice allocation for an audio processor like that of FIG. 1.

FIGS. 6A-6B illustrate a flow chart for handling a new event in a process like that of FIG. 5, including voice stealing and dynamic voice allocation.

FIGS. 7A-7B illustrate a flow chart for voice stealing in a dynamic voice allocation process like that of FIGS. 6A-6B.

FIG. 8 illustrates a flow chart for performing system overage protection in a process like that of FIG. 5.

### DETAILED DESCRIPTION

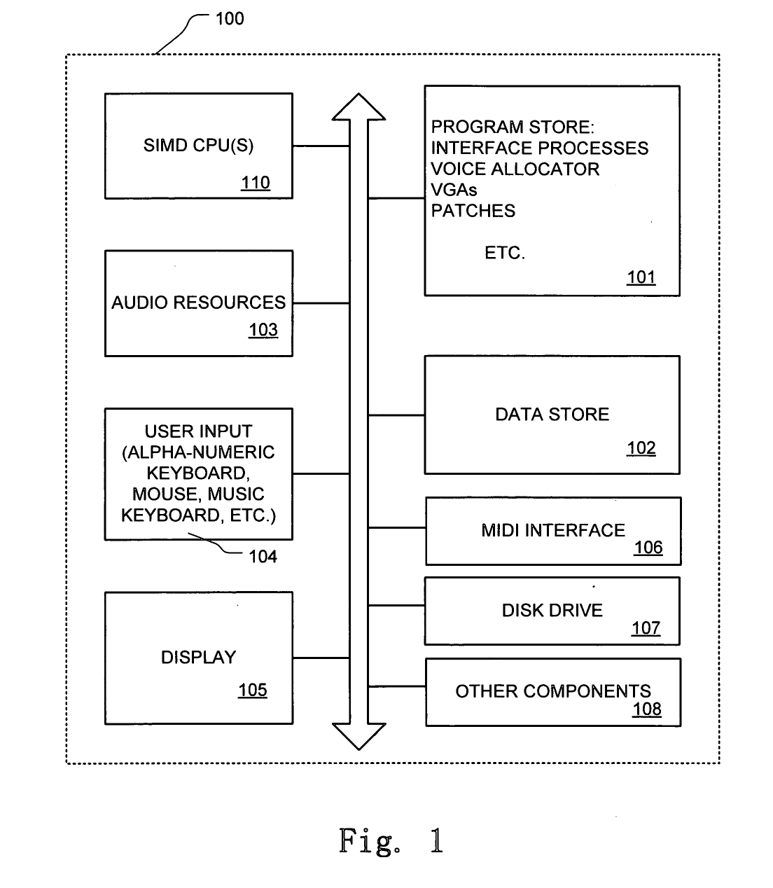

A detailed description of embodiments of the present invention is provided with reference to the FIGS. 1-8.

FIG. 1 is a simplified block diagram representing a basic computer system 100 configured as a music synthesizer, including data processing resources, including memory storing instructions adapted for execution by the data processing resources. The data processing resources of the computer system 100 include one or more central processing units CPU(s) 110 configured for vector processing, such as single-instruction-multiple-data SIMD CPU(s), program store 101, data store 102, audio resources 103, user input resources 104, such as an alpha-numeric keyboard, a mouse, a music keyboard, and so on, a display 105, supporting graphical user interfaces or other user interaction, a MIDI interface 106, a disk drive 107 or other non-volatile mass memory, and other components 108, well-known in the computer and music synthesizer art. The program store 101 comprises a machine-readable data storage medium, such as random access memory, nonvolatile flash memory, magnetic disk drive memory, magnetic tape memory, other data storage media, or combinations of a variety of removable and non-removable storage media. The program store 101 stores computer programs for execution by the CPU(s) 110. In the illustrated embodiment, the program store 101 includes computer instructions for synthesizer interface processes, voice generation algorithms (VGAs), patches which configure VGAs for specific sounds, and other synthesizer processes. The voice generation algorithms implement respective voice models like PCM, analog, plucked string, organ and so on.

Processes for managing the audio resources, including transducing the digital output waveforms produced by the synthesis procedures into analog waveforms and/or into to sound, mixing the digital output waveforms with other waveforms, recording the digital output waveforms, and the like, are also implemented using computer programs from the program store 101. Logic in the computer system to execute procedures and steps described herein includes the computer instructions for execution by the CPU(s) 110, special purpose circuitry and processors in the other data processing resources in the system, and combinations of computer instructions for the CPU(s) 110 and special purpose circuitry and processors.

Also, in the illustrated embodiment, the program store 101 includes computer instructions for dynamic voice allocation (voice allocator) and for other data processing resource management for real time audio synthesis. The voice allocator includes routines that perform resource cost management, resource allocation, and voice stealing algorithms such as described here. The voice allocator in some embodiments is arranged to manage all synthesizer voice modes, including polyphonic/monophonic, unison, damper and sostenuto pedals, poly retrigger, exclusive groups, etc.

Voice generation algorithms VGAs include processes to produce sound, including processes that implement voice models. A voice model is a specific synthesis algorithm for producing sound. In embodiments described herein, voice models compute audio signals using vector processing to produce several distinct voices at a time as a vector group, in reliance on the SIMD instruction architecture of the CPUs or other vector processing architectures. The individual voices of the vector group may all be playing different patches, or parameterizations, of the model. Example voice models implemented with vector processing as described herein include: (1) a PCM synthesizer with two low frequency oscillators LFOs, a multimode filter, an amplifier, etc.; (2) a virtual analog synthesizer with two sawtooth oscillators, a sub-oscillator, four LFOs, a filter, etc.; (3) a physical model of a resonating string for guitar-type sounds; and other models as known in the art.

In vector processing systems, including SIMD systems as described herein, dynamic voice allocation on a multi-timbral synthesizer with multiple voice generation algorithms is accomplished, in which each algorithm simultaneously calculates multiple voices using vector processing. Given a set of fixed memory and processing resources, the voice allocator manages existing and new voices within the limits of the system. A new event may require multiple voices from multiple voice algorithms. Voice data is organized in algorithm-specific vector groups, and the voice allocator must consider the arrangement of existing vector groups when accounting for the cost of new events, and stealing existing resources. The overall resource impact of a new event is determined in advance in an embodiment described, and if these requirements would cause the system limits to be exceeded, existing resources will be stolen using a hierarchical priority system to ensure that only the minimum resources are stolen to make room for the new event. Additionally, the cost impact of multiple voices started by a single event will be amortized across multiple subrate ticks, to avoid excessive cost impact on any one tick; however a means is provided to ensure that certain voices are guaranteed to start together on the same tick to ensure phase accuracy. A mechanism is described to continuously defragment the vectorized voice data to ensure that only the minimum number of vectors is processed at any time, and to enable the optimal system for voice stealing in a vectorized system.

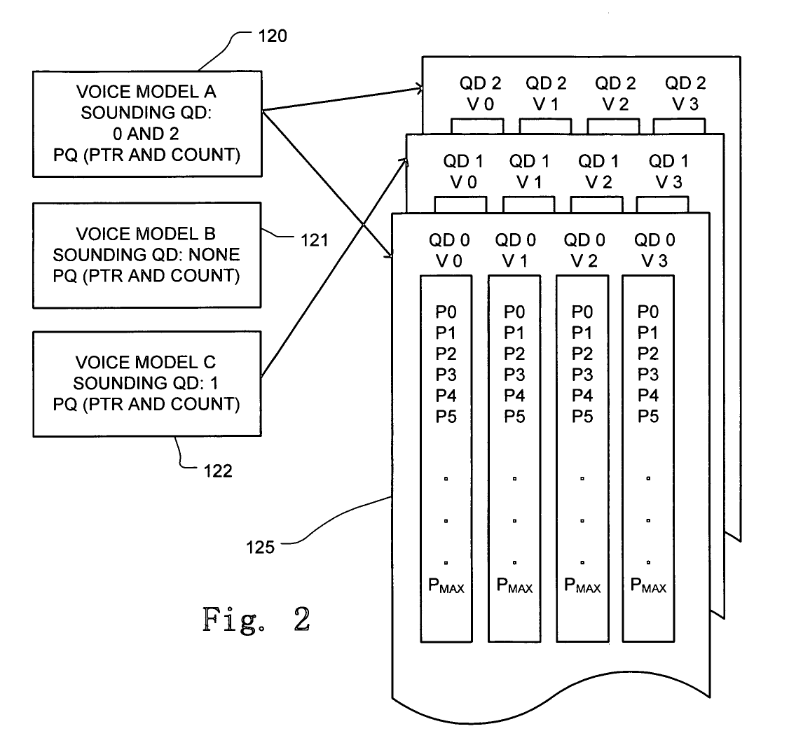

FIG. 2 illustrates an organization of data for voice models in a SIMD vector processor, with four vectors per instance of a voice generation algorithm. According to the organization illustrated, a voice model record for each voice model implemented by the system is maintained by the voice allocator. Thus, Voice Model A is represented by record 120, Voice Model B is represented by record 121, and Voice Model C is represented by record 122. A vector group specifies a set of voices that are processed simultaneously for a certain voice model. In the examples described, a four vector group is used, and is referred to as a quad. However, it should be clear that the examples, and the invention in general, can be extended to fit a vector group of any size. It can be seen with reference to FIG. 2, that a SIMD based processor executes instances of vector-based voice generation algorithms that are configurable to generate N voices for each instance, where N is an integer greater than 1, and N=4 in the illustrated embodiments.

FIG. 2 illustrates data structures 125 corresponding to the three quads, QD0, QD1 and QD3. A set of parameter values P0 to PMAX referred to as a patch is associated with each vector V0, V1, V2, V3 in the quad for a particular instance of a voice model. The records for the voice models include pointers to sounding quads executing voices according to the voice generation algorithm for the model. In the organization illustrated, Voice Model A is used to execute two quads, QD0 and QD2. Voice Model B is not executing, and is therefore not associated with any sounding quad. Voice Model C is associated with sounding quad QD1. A sounding voice for a particular voice model is allocated to a vector within a quad. For example, one sounding voice of Voice Model A is allocated to the vector V1 in the quad QD0. The processor resources allocated for sounding a voice include the corresponding quad and the corresponding vector within the quad. In a SIMD vector processing environment, the cost of executing a single voice, in terms of CPU cycles, is basically the same as the cost of executing four voices in a quad. It should be noted that some models may be more expensive to process than others, so for example, one quad of voice model B may require twice as much processor resource cost as one quad of voice model A.

The voice allocator in the embodiment being can be characterized as maintaining a partial quad parameter PQ(PTR AND COUNT) associated with each voice model record 120-122. As a result of the defragmentation process described, there can only ever be one or zero partial quads for a voice model. The partial quad parameter can be null, indicating that there are either no sounding quads associated with the voice model, or all of the sounding quads are full with all four vectors being executed for corresponding sounding voices. If the partial quad parameter is not null, then it includes a pointer PTR indicating a partially allocated quad, and a COUNT value indicating the number of free vectors available in the quad, such as a count of the number of allocated vectors, or a count of the number of free vectors.

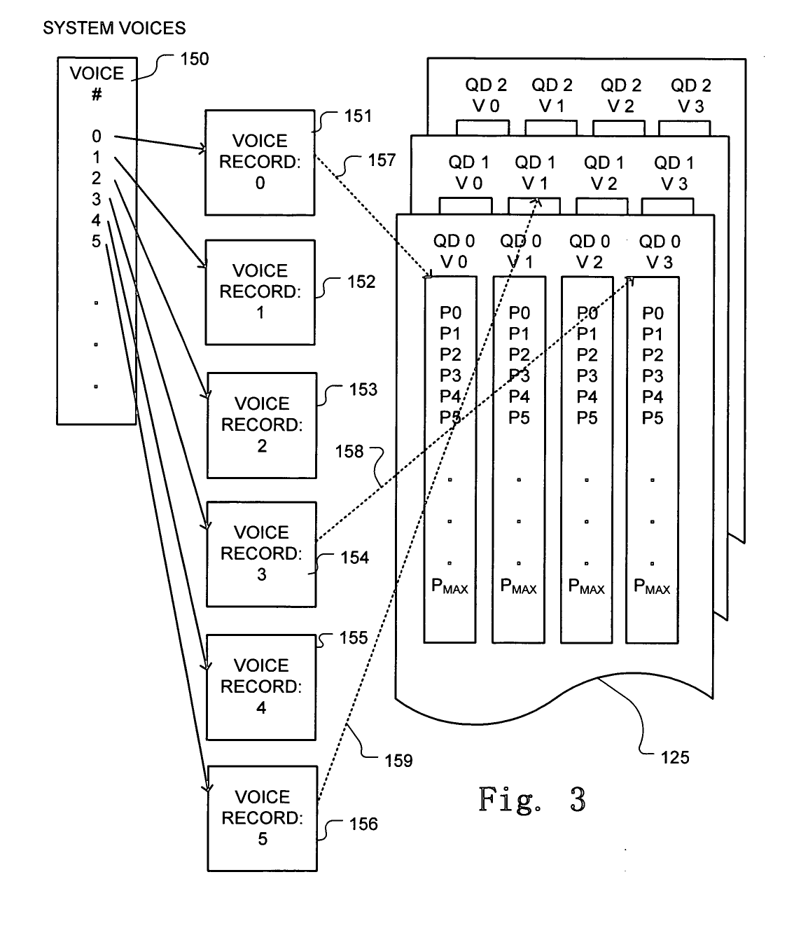

FIG. 3 illustrates additional information maintained by the voice allocator. The voice allocator maintains a list 150 of all voice records in the system, along with pointers to such records. In FIG. 3, voice records 0-5 are represented by blocks 151-156. A voice record contains information about an allocated voice including note number, voice model type, velocity, program slot, parent voice cluster, and so on. The voice allocator's voice list contains pointers to voice records, to facilitate swapping, when a voice is moved. Thus, each voice record in the illustrated example includes a voice number, the note with which the voice is associated in the synthesizer, the velocity associated with a voice and a slot pointer indicating the position of its corresponding program in a MIDI channel, along with other parameters. The voice number is utilized by algorithms in the voice allocator to move the voice among quads and vectors within the quads for the purposes of managing allocation and defragmenting quads as voices are added and stolen from the sounding list. Each voice is inherently tied by its voice number to a specific slice of the subrate vector data and of audio rate vector data. The voice records also maintain pointers to the allocated vector within the allocated quad for the corresponding voice. Thus, for some examples, the voice record 151 for voice record 0 is associated 157 with the vector V0 in quad QD0. The voice record 154 for voice record 3 is associated 158 with the vector V3 in quad QD0. The voice record 156 for voice record 5 is associated 159 with the vector V1 in quad QD1. A voice can be moved from one vector position to another, and from one quad to another, by swapping its voice number with that of a freed voice record, and updating the voice list 150, and by copying the subrate and audio rate vector data from one slice to another. Given the number of voices allocated for a given voice model, one can determine the number of free voices in the partial quad by the “modulo X” operation, where X is the number of vectors per quad, which gives the result equal to the remainder of dividing the number of vectors needed for the voices in the voice list by X.

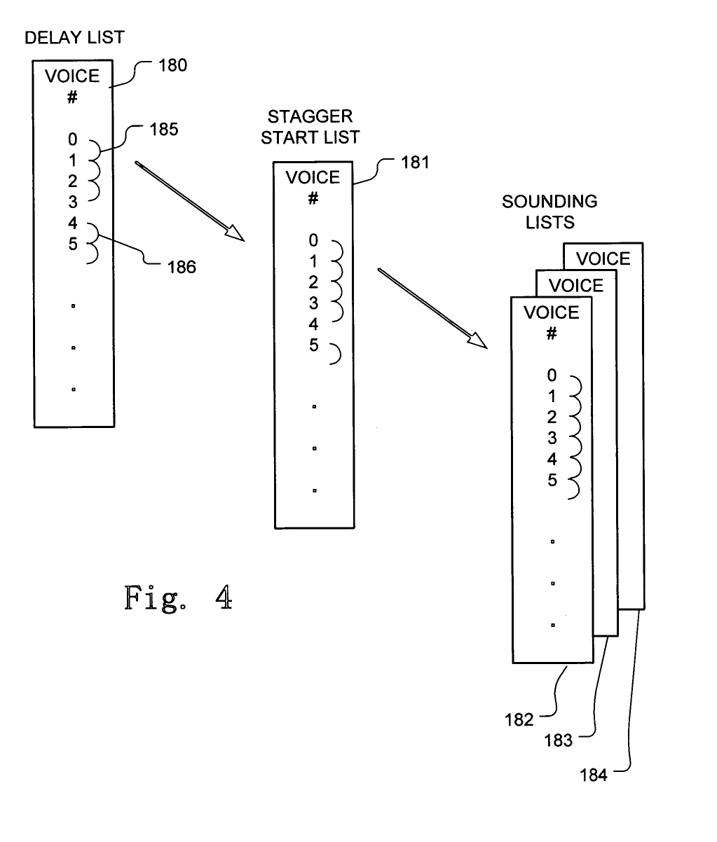

FIG. 4 shows additional lists kept by the voice allocator, including a delay list 180, a stagger start list 181, and a set of sounding lists 182, 183, 184. Use of the lists shown in FIG. 4 is described in more detail below. However certain aspects of the records can be described. The delay list 180 is utilized to hold voice clusters pending allocation of resources to execute a cluster, and to point to pending voice records for the clusters. The delay list 180 associates the voices in the list by clusters using for example a linked list structure. Thus, the illustrated delay list 180 includes the voice numbers 0-5. Voice numbers 0-3 in the delay list 180 are associated with a cluster by the link structure 185. Voices 4 and 5 in the delay list 180 are associated with another cluster by the link structure 186.

The stagger start list 181 is utilized to hold voice clusters for which resources have been allocated and that are to be started in a current frame, if the number of starting voices per frame does not exceed a limit of the system. Voices in the stagger start list 181 are also associated into clusters by link structures. Also, voices in the stagger start list 181 are associated by indicators when they must be started at the same time, such as a stereo pair of voices that are always sounded in phase. The sounding lists 182-184 are utilized by the voice allocator for allocation and stealing of resources, and maintaining priority among the sounding voices. The sounding lists 182-184 also include lists of voices that are linked into clusters by link structures. In embodiments of the voice allocator, resources are allocated and stolen for clusters, so that the voices in a cluster are allocated to processor resources, or stolen at the same time. Each time a new cluster is allocated for starting, the new cluster will be added to one of the sounding lists:
1. Voices held across a performance change.
2. Voices with Amp EG in release phase. A note-off has been received for these voices and the Amp EG is releasing.
3. Voices held by damper pedal or hold function. A note-off has been received for these voices, but they are being sustained by the damper pedal or hold function.
4. “Active” voices. A note-off has not been received for these voices.
   Some embodiments implement a priority mechanism, where lists 2, 3, and 4 above are repeated for voices with higher priority, in which for each priority level, three more lists (corresponding with lists 2, 3 and 4, for example) are used.

When an event occurs, or other change happens, voice clusters or voices are moved among the lists. The lists are used as described below for determining clusters to steal to make room for a new cluster.

A cluster of voices comprises a set of voices or pending voice records, which correspond to a particular note-on event on a program slot. By grouping voices into clusters, complex sound made of multiple voice layers is started, stopped and stolen as a group. This way, the complex sound made as the sum of several components by the synthesizer does not have some of its components stolen while others continue to sound. A single note-on event for a combination may create multiple clusters, with each cluster corresponding to a slot in the combination.

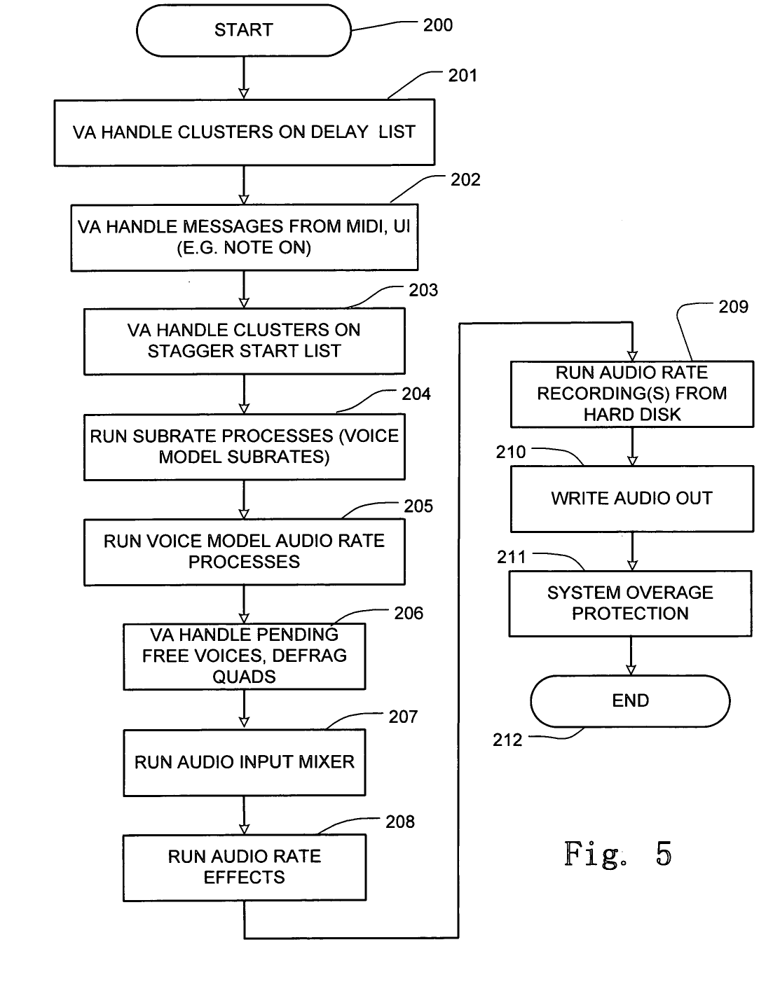

FIG. 5 illustrates an example of a basic synthesizer engine process, with dynamic voice allocation, and is executed by a processor such as that represented by FIG. 1, once per frame, or once per subrate tick. In an exemplary embodiment, a frame includes for example, 32, 64 or 128 audio rate sample times, where the audio rate is for example 44.1 kHz, 48 kHz, or 96 kHz, so that a frame of samples (e.g. 32, 64 or 128 samples) is generated for each subrate tick and written to an output buffer. This main loop executes tasks which accomplish the following:
1. Respond to incoming performance controls and allocate, remove, or update voices as needed.
2. Compute voices. Each frame, the engine must compute all of the voices sounding in that frame and write the results into buffers for further effects processing, if any.
3. Compute effects processing. Each frame, the engine must read the buffers containing the computed voice data for that frame and process them according to the effects settings selected by the user. The processed sound data is then written to output buffers.

The method described for dynamic voice allocation executes on a multi-timbral synthesizer with multiple voice generation algorithms, in which each algorithm simultaneously calculates multiple voices using vector processing.

Given a set of fixed resources, the voice allocator manages sounding and new voices within the limits of the available resources. The limited resources include both CPU speed, and memory, and include:
1. Limited CPU speed.
2. Limited number of voice quads, to limit overall cache usage.
3. Limited number of voices that can start on any one tick.

The cost of a note-on event is calculated in advance of allocation of the cluster of voices associated with it, and compared to the current cost and the maximum cost. When the cost is excessive, voices can be stolen to free resources for the cluster associated with the note-on event. For each required voice in the event, the voice allocator determines the cost to start the voice. If the voice model for the voice has a partial quad, then a voice from the partial quad can be used, without the cost of allocating a new quad. However, if there are no partial quad voices available, a new quad must be allocated, at a cost specified by the model quad cost. Also, each voice may specify some additional cost, not included in the model quad cost, and this is also tallied when calculating the event total cost.

The value of a cost parameter used as a metric for a voice model can be determined in advance by profiling the performance of the voice model while running voices in various situations and assigning cost empirically. The cost metric is typically an indicator of CPU usage while playing under stress (for example, under simulated worst case conditions, like total cache invalidation). The number can be in arbitrary units (for example, as a relative number compared to a reference model), or in some more specific units (like actual CPU cycles used per tick). Alternatively, this cost metric could be determined at runtime by monitoring the performance of the voice model in action, and applying a normalizing formula to determine the value of the cost parameter.

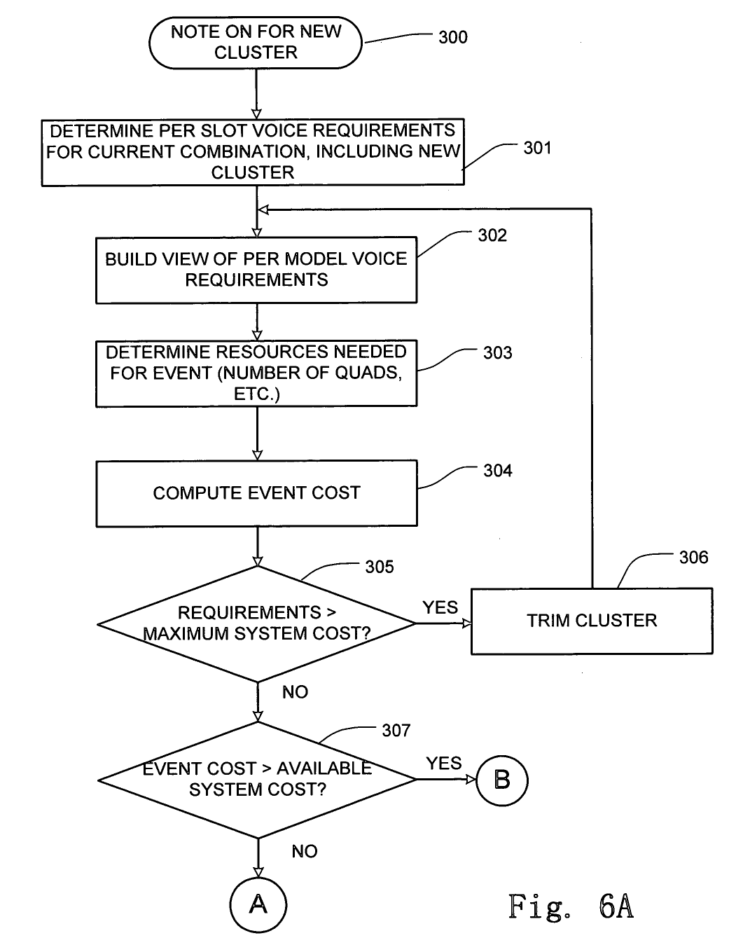

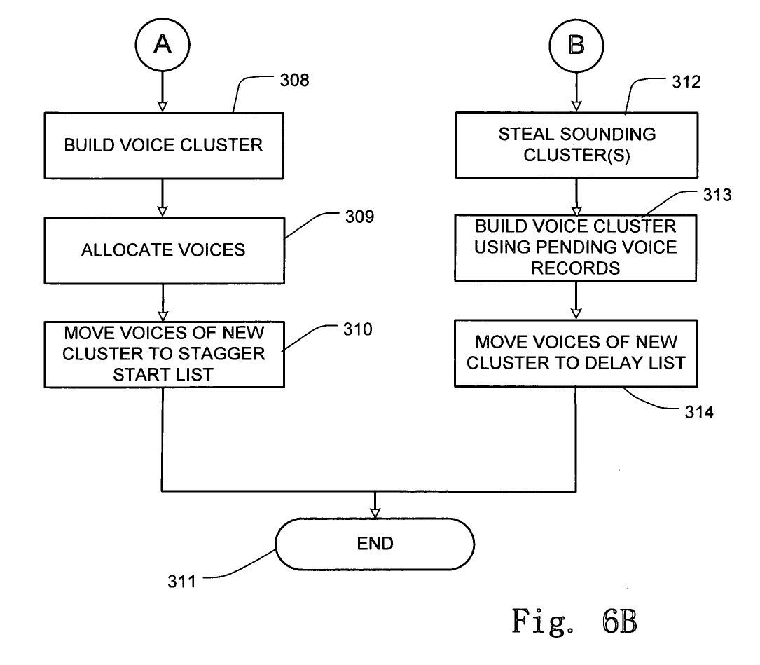

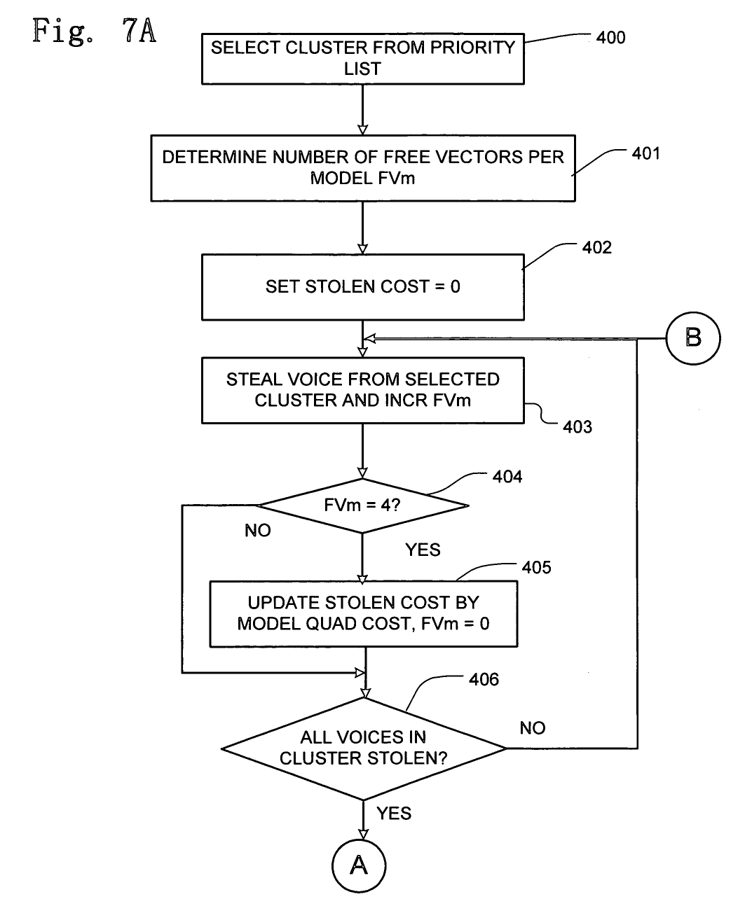

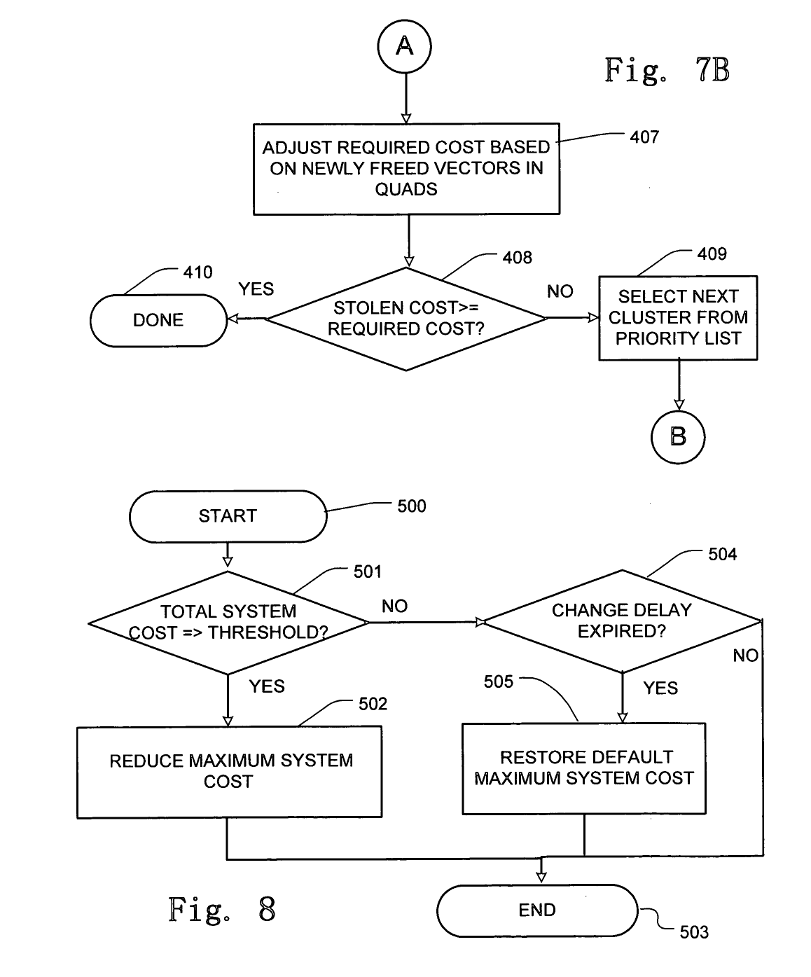

An example subrate procedure starts at a particular time at block 200, and a record of the time is kept. Next, clusters on the delay list are handled, by moving them to a stagger start list to be started in block 203 if possible within this same tick, leaving them on the delay list, or otherwise handling the clusters (block 201). In the next step, messages from the user interface or from a MIDI channel are handled, including note-on events, note-off events, and other events which can cause the need to allocate or release voices (block 202). A representative procedure for handling note-on events can be understood with respect to the description of FIGS. 6A-6B and FIGS. 7A-7B below, and involves voice allocation and voice stealing as needed. In the next step, clusters on a stagger start list are handled by moving a number of voices from the stagger start list which are allowed to be started within the given subrate tick into a sounding voice list, and starting the voices (block 203). Next, the voice model subrate processes, such as envelope processes and LFO processes are executed (block 204). In the next step, voice model audio rate processes are run to generate audio samples at the sample rate (block 205). In block 206, pending free voices are handled by the voice allocator (freed by subrate amp envelopes completing their release), including the fragmentation of quads and other housekeeping processes associated with dynamic voice allocation. In block 207, audio input mixer processes are executed at the audio rate. Audio rate effects are executed in block 208, and recordings to or from hard disks are run at the audio rate in block 209. The audio data is written to output buffers in block 210. A voice allocator runs a system overage protection routine in block 211, an example of which is described in more detail below with respect to FIG. 8. After system overage protection in block 211, the subrate process loop ends (block 212).

In order to ensure optimal voice processing, sounding voices must be maintained as a set of defragmented quads. Whenever a vector is freed after its voice is released or stolen, the voice allocator will move a sounding voice as necessary to maintain a completely defragmented array of sounding voice quads in step 206.

Every voice model is always in one of these situations:
1. no sounding quads.
2. only one sounding quad, which is full or partially full.
3. one or more full quads, and no partial quad.
4. one or more full quads, and exactly one partial quad.

Whenever a voice is freed, a process operates do the following:

```
if the voice is the last in the quad
    free the quad, and set the voice model's PartialQuad to NULL.
else if the voice model's PartialQuad is NULL
    set the voice model PartialQuad to the quad containing this voice
    free the voice immediately
else if the voice is in the model's current PartialQuad
    free the voice immediately
else
    move a used voice from the model's PartialQuad to replace this
voice
```

The process of moving a voice is as follows:
1. Swap the two voice structures in the voice allocator's own list of voices, and swap the internal voice numbers in the voice structures.
2. For both the subrate and audiorate vector data, copy from the source slice of the vector data to the target slice.
3. Fix any inter-structure pointer addresses contained in the vector data, by offsetting the address by the distance from the old to the new slice.
4. If the quad for the from Voice is now empty, then free it.

One consideration with moving a voice in the same subrate cycle in which the voice frees is that voices may be freed as a result of subrate processes (like an amp envelope running, and causing the voice to free at the end of release). If the subrate process is iterating over a list of voices, and in the middle of the iteration a voice frees and rearranges the voices, then the integrity of the remainder of the list may become invalid. Therefore, the preferred embodiment establishes a pending free list. Whenever a voice frees, it is added to this list. The actual move and defragmentation should happen at the end of the subrate tick, after subrate and audiorate processing are completed, such as a block 206 of FIG. 5.

Since starting a voice is a rather CPU-expensive operation, voices are stagger started in the described embodiment, so that no more than some maximum number of voices will start in any one tick. Stereo voices are guaranteed to start on the same tick, for phase accuracy.

When a note-on event is found, the voice allocator determines how many voices of each voice model will be required in response to the note-on event and calculates a total event cost. Voices are stolen as needed if the processing power required to start the new note-on event exceeds the available processing power. A new voice cluster is built and it is put onto either the stagger start list, or the delay start list if voices were stolen. Voices are stolen in age and priority order, giving no preference to voice model in the described embodiments. Voices for model A can be stolen to make room for model B. The minimum number of voices are stolen in preferred embodiments to make room for the new event's voice requirements. Clusters of voices are always stolen together in preferred embodiments.

The voice model algorithms perform their subrate and audiorate processing in vectors as discussed above, using special vector processor instructions (e.g. SIMD). For a quad-processing system, four voices are calculated at a time. Therefore, a single voice for model A takes basically the same amount of overall system cost to process as four voices. Nine voices would use three quad cost units, while six voices would use two. The voice allocation mechanism must consider this when accounting for system cost, stealing, etc.

FIGS. 6A-6B illustrate a flow chart for handling a note-on event for a new cluster, such as may occur during block 202 of FIG. 5. Thus, for a note-on event, the voice allocator starts a process at block 300. In the first step, the voice allocator determines the slot voice requirements for the current combination, including one or more new clusters (block 301). The voice allocator then builds a view of the per model voice requirements, taking into account available voices in model partial quads, if any (block 302). The amount of resources needed for the event is determined, including the number of quads (block 303). Based on the amount of resources needed for the event and the sounding voices at the time, a total event cost is computed (block 304). If the total requirements for the combination of voices to be started in response to this note-on event, without considering other sounding voices, exceeds a maximum system cost parameter, as determined at block 305, then the process loops to block 306, and trims the number of voices in the cluster associated with the note-on event according to a priority scheme. If at block 305 it is determined that the note-on event does not require more than the maximum system cost, then the computed event cost is compared with the available system cost at block 307. If the computed event cost does not exceed the available system cost at block 307, then the procedure branches to point A of FIG. 6B. If the computed event cost exceeds the available system cost parameter at block 307, then the procedure branches to point B of FIG. 6B.

From point A in FIG. 6B, where the event cost does not exceed the available system cost parameter, the voice allocator builds the data structure for the voice cluster in block 308, allocate the voices in block 309, and moves the voices of the new cluster to the stagger start list in block 310. After moving the voices to the stagger start list in block 310, then the process ends at block 311 and proceeds for example with step 203 of the process of FIG. 5.

From point B in FIG. 6B, where the event cost does exceed the available system cost parameter, then the voice allocator initiates a process to steal one or more sounding clusters in block 312 to free resources needed for the new cluster. Next, the voice allocator builds the data structure for the voice cluster in block 313, using pending voice records, and moves the voices of the new cluster to the delay list in block 314. The voices records of the new cluster in the delay list are associated with a delay parameter, which will be checked in the next cycle through the process of FIG. 5. When the delay parameter expires, the voices of the cluster are moved from the delay list to the stagger start list as described above. The delay parameter is set long enough that the voice allocator has sufficient time to complete the process of stealing clusters of block 312. After placing the new cluster on the delay list, the process ends at block 311.

As can be seen from the simplified flow chart in FIGS. 6A-6B, when a note-on arrives for a specific MIDI channel, the voice allocator looks at the current combination and, for each program slot set to that channel, asks for a voice-requirement specification. For example, the following question is resolved for each program associated with the note-on event: “Piano Program in program slot 1, how many voices do you need”? The program can specify any number of voices, including zero, depending on the program parameters. The voices can be for any voice model. The specification is in the form of voice request records, which can contain further information about the voice including per-voice extra cost, as specified by the program. Basically, a process for step 301 is like the following pseudocode:

```
for each program slot on the note's MIDI channel
    if note is in slot key/velocity zone
        ask slot to provide list of voice request records
```

After completing this iteration, the voice allocator has a per-slot set of voice requirements. “Slot 1 requires 2 voices for model A, slot 2 requires 0 voices, slot 3 requires 2 voices for model A and 6 voices for model B, etc.” There is also a sum total of voice extra cost.

Then, as represented by step 302, the voice allocator iterates over this list, building a second view of the event requirements, arranged by voice model. “Model A requires 4 voices, model B requires 6 voices”.

Now, the actual event cost can be calculated, by determining how many new quads will need to be processed for each model, and multiplying these by the quad-cost of each voice model. The sum of the model costs plus the sum of all voice extra costs is the total event cost of step 304.

In the above example, three PCM voices and six analog voices will require one new quad for PCM, and two new quads for Analog. If the PCM quad cost is 4000 and the analog quad cost is 8000, then the total event cost is 4000+16000, or 20000 (assuming no voice extra cost).

Now the voice allocator can compare the event requirements with the system maximum cost. If the event requires either more voice quads than the system can perform (even if no other voices are sounding), or it requires more cost than the CPU can handle, the event must be trimmed back. An example would be a complex combination which requires hundreds of voices, exceeding the system max cost limit. This trimming is performed, per program slot, reducing the requirements until the event cost is lower than the system limits.

Pseudocode for trimming back excessive event requirements corresponding with step 306, follows:

```
eventCost = sum of all slot requirements' costs
loop from low priority to high priority
    for each slot matching that priority
        for each slot's voice requirements, while the eventCost >
        maxSystemCost
        or the requiredNumQuads > maxSystemQuads
            remove a voice request record from the list
            update eventCost and requiredNumQuads
            if that voice request was part of a stereo pair
                also remove the voice request for the stereo
                pair
                update eventCost and requiredNumQuads
```

Now, the event cost, including the requirements for the note-on event plus the current sounding cost, is compared with the available system cost corresponding with step 307. If the event cost exceeds the available system cost, then some of the sounding voices must be stolen as indicated at block 312.

When voices are being stolen at block 312 and the voice cluster for a new note-on event is built at block 313, the cluster is moved to the delay list at block 314 to handle the time for the stealing algorithm to complete. When a voice is stolen, its audio is ramped down over some period of time. If the voice were immediately freed, there could be an audible snap. Because of this steal ramp, the voice record cannot be freed and made available to the new event which required the steal, until after the ramp down period. The new voice record cannot be allocated until the end of the ramp down. In a rhythmic pattern, if some events require stealing and some do not, there is the danger of jitter, where some voices start immediately, while others start after a delay (for stealing).

In order to prevent jitter, one solution is to delay all note-on events by the steal time, whether they require stealing or not. This way, those that require stealing will use the delay time to ramp down the stolen voices, and those that do not require stealing will simply wait. In a rhythmic pattern, the rhythm pattern will be preserved and jitter will be minimized. The downside of this is that latency of all note-on events is increased by the steal time. Clearly, the steal ramp time must be as short as possible.

When a new note-on event requires stealing, then the new voices cannot be allocated until the stolen voices have completely freed. In this case, the voice allocator sets up pending voice records as placeholders for voices to be allocated after some delay. The cluster containing the pending voice records is placed on the delay list, with a timestamp indicating the delay.

Once the delay time is complete, the voice allocator processes the pending records in the cluster, allocating actual voices, and then moves the cluster from the delay list to the stagger list.

Every subrate tick (see block 201 of FIG. 5), delayed voices are processed as follows:

```
for each cluster on delay list
    if the cluster timestamp == now
        for each pending voice in the cluster
            allocate an actual voice, copying spec into voice
            structure
            free the pending voice record
        move cluster from the delay list to the stagger list
```

Since starting a voice is an expensive operation in terms of processor resources, the voice allocator will limit the number of voices started each tick using the stagger start list (see block 203 of FIG. 5). If a note-on event requires six voices, and the maximum voices to start per tick is two, then the event will take three ticks to completely start.

The stagger start mechanism will ensure that stereo pairs of voices will start on the same tick. Continuing the above example, if the second and third voices in the list are a stereo pair, then only a single voice will start the first tick, so that on the next tick the second and third voices can start together. The total event will then take four ticks to completely start. Representative pseudocode for the stagger list processing follows:

```
numVoicesProcessed = 0
for each cluster on stagger list
    for each voice in the cluster
        if numVoicesProcessed >= kMaxStartsPerTick
            exit
        if voice is part of stereo pair and
            numVoicesProcessed+2 > kMaxStartsPerTick
            exit
        tell voice to start
```

If the time to process a voice on the stagger start list is non-deterministic, then a mechanism may be put in place to determine the total time required to start the voices. If amount of time needed to start a next voice exceeds some threshold, the stagger start algorithm can simply wait until the next tick (or longer, if necessary) before starting the next voice.

A basic flow chart for a voice stealing algorithm corresponding with block 312 of FIGS. 6A-6B is illustrated in FIGS. 7A-7B. A first step in the algorithm is to select a cluster from a priority list of sounding voices (block 400). The sounding voices are organized in the priority list, by cluster, as mentioned above with reference to FIG. 4.

For a selected cluster, and voice models within the cluster, the process determines the number of free vectors per model, FVm (block 401). The “stolen cost” parameter is set to zero at block 402. Next, a voice from the selected cluster is stolen and the parameter FVm is incremented for the voice model of stolen voice (block 403). The process determines whether the number of free vectors FVm is equal to four (for a quad based vector processor) at block 404. If the number of free vectors is four at block 404, then the stolen cost is updated by the cost of a quad of the current model (block 405). If at block 404, the number of free vectors is less than four, or after a block 405, then the process determines whether all the voices in the current cluster have been stolen (block 406). If all the voices have not been stolen, then the process loops back to step 403 to steal a next voice in the cluster. If all the voices of the cluster have been stolen at block 406, then the process proceeds to point A in FIG. 7B.

At point A in FIG. 7B, the process adjusts the cost needed to be stolen based on newly freed vectors (block 407). This procedure takes into account the fact that even if a new quad has not been freed, the requirements for the event may be reduced if one or more vectors are freed within the sounding quads, and the requirements of the new event for the voice model can be reduced by filling the freed vectors without requiring an additional quad. The next step determines whether the stolen cost is greater than or equal to the required costs for the stealing process (block 408). If the stolen cost is not high enough, then the process proceeds to select a next cluster from a priority list (block 409) and loops to point B in FIG. 7A, in which voices from the next cluster are stolen. If the stolen cost is high enough at step 408, then the process is done (block 410).

When a voice is stolen, it can be assumed that when it frees, the model voices remain completely defragmented, with either no partial quad, or exactly one partial quad, due to the defragmentation process of handling free vectors in the run engine, with either no partial quad, or exactly one partial quad. So, in order to free a quad of model cost, the steal process may simply steal any four voices from the model. The run engine moves voice records and defragments the quads, ensuring that removing four voices from a given model will eliminate one quad of vector processing.

When a steal is necessary, the event's requirements are split up per-model with number of voices, as described above.

One approach to determining the cost of a new event is based on setting up a ModelRequirements class containing an array, per-model, of required vector count, and extra cost. The class also maintains a total cost requirement (sum of all model quad costs+extra costs). The initial requirements are not adjusted by the current number of free vectors in model partial quads. If model A needs three voices, and the model cost is 4000, then it will have a cost of 4000 and require 3 voices. The stealing algorithm adjusts this requirement as needed by a process corresponding to block 407.

A representative cost-determining algorithm first initializes an array of numFreeModelVoices[numModels] to the number of free voice vectors in each model's PartialQuad, or 0, if there are is no PartialQuad. This array initialization should only happen once per tick, at block 401.

During steal, the process keeps track of stolenCost, starting at 0. Each time a voice is stolen for a model, increase the numFreeModelVoices[model] by the number of voice vectors freed. If numFreeModelVoices[model] reaches 4, then increase stolenCost by the modelQuadCost.

After stealing each cluster, determine a per-model freeVoiceCount, and use that to temporarily offset the total required cost, in determining whether stealing is complete. The process checks whether the required cost can reduce the per-model required cost needed to be stolen, by checking whether the number of freed voice vectors for the model is greater than or equal to the number of voices in that model modulo 4 (or modulo x, where x is the number of vectors in a quad), required to be stolen for the new cluster. If so, then some or all of the new voices in that model can be allocated to the remaining partial quad, and the required cost to be stolen can be reduced by the quad cost.

If the stolenCost>=the requiredcost, then the steal cycle is complete.

Pseudo code for a representative steal process follows:

```
Steal(totalRequiredCost):
    // numFreeModelVoices[i] value will always be 0-3
    if this is the first time stealing on this tick
    Initialize array numFreeModelVoices[numModels] to the
        number of free voices in each model's PartialQuad
    stolenCost = 0
    Loop over sounding clusters in reverse priority and age order (7
lists)
        // steal all voices in cluster
        For each voice in cluster
            Steal Voice
            numFreeModelVoices[stolenModel] += 1
            if numFreeModelVoices[stolenModel] == 4
                numFreeModelVoices[stolenModel] = 0
                stolenCost += stolenModelQuadCost
    // now determine if done stealing
    // first check for each model if the currently available
    // free voices in the partial quad would lower the model
    // requirements by a quad, thus lowering
    costCheck = totalRequiredCost
    for each model in ModelRequirements
        if numFreeModelVoices[model] != 0
        numVoicesRequired = num voices required for model
        numVoicesRequired %= 4
        if numVoicesRequired != 0 and
          numFreeModelVoices[model] >= numVoicesRequired
            costCheck =− modelQuadCost
    // done when stolenCost exceeds requiredCost
    if stolenCost >= costCheck
        exit
```

The stealing priority for voice allocation as described herein can be understood with reference to an example starting from a condition when no voices are sounding and including the seven events listed below, and the sounding lists described above. For this simple example, the total number of voices available in the system is 4 voices.
1. note-on, C4. Add new cluster to sounding list 4 since it is an active voice.
2. note-on, D4. Add new cluster to sounding list 4 since it is an active voice.
3. note-on, E4, Add new cluster to sounding list 4 since it is an active voice.
4. note-on, F4, Add new cluster to sounding list 4 since it is an active voice.
5. note-on, G4,Cost is>Max, so we must steal.
6. note-off, E4. Cluster moved from sounding list 4 to sounding list 2.
7. note-on, A4. Again, cost is>Max, so we must steal.

At step 5, stealing first looks at list 1 but it is empty, as are 2 and 3. List 4 has a list of the active voice clusters in the order they were played: C4, D4, E4, F4. So, it steals them in this order until the new cost is no longer>max. In this case, it only has to steal the first one, C4.

So, the cluster for C4 is stolen and G4 is added to the end of the active list 4. Consider the next event in the example.

At event 6, the E4 voice is removed from the active list, and put onto list 2 for voices that have received a note-off, but the amplifier envelope function “Amp EG” is still in the release phase. In other words, we are handling the note-off, but the voice is still sounding because of the Amp EG release time. For this example, let us assume that the Amp EG has a long release time.

At this point, list 2 (releasing voices) has just one item: E4. The active voice list 4 has: D4, F4, G4.

At event 7, again Cost is>Max, so we must steal.

The stealing algorithm first looks at list 1, but it is empty. List 2 however, has one item on it, E4. This voice is stolen, and the new note, A4, is added to the active list 4.

At this point, all of the lists are empty except for the active voice list which has D4, F4, G4, A4.

Note that when the request for A4 was handled, E4 was stolen, even though D4 was an older voice. Because E4 was in its release phase, it was given a lower priority for stealing, so it got stolen first. If the E4 voice had completed its release phase, that voice would then have been removed from list 2. Then the request for a new note-on would not require stealing at all.

When stealing is required, it looks at list 1 and steals as many voices as it needs. If more voices need to be stolen (because list 1 was either empty or did not have enough voices on that list) then we move on to list 2. Again, we steal as many voices as we need from list 2. If we still do not have enough voices, we move on to the next list, and the next, etc. Since all of the sounding voices are on exactly one of these lists, we will eventually get all the voices we need.

Note that the user has the ability to mark certain slots with a priority level. This simply causes the voice clusters for that slot to be loaded into higher numbered stealing lists 5-7 (or 8-10, etc.), making them less vulnerable to stealing.

The system overage protection step 211 of FIG. 5 can be implemented as shown in FIG. 8. The audio processor in a preferred system is multi-buffered, to allow the system to absorb temporary overages (where the synthesizer has not completed processing all of its required work, by the time another audio interrupt arrives). However, there still may be situations in which the system runs overtime for too many consecutive ticks.

An overage-protection algorithm monitors the overall CPU usage during each subrate tick, and tracks both a long term running average, and a short term indicator based on the interrupt misses. This is to ensure that factors not accounted for in the voice allocator, such as UI activity, networking interrupts, etc., do not cause a buffer underrun or audible glitch.

A basic system overage algorithm is illustrated in FIG. 8, starting at block 500. The total system CPU cost is determined each tick by reading the CPU time before starting the processing, and reading it again after completion, and taking the difference as the total system CPU cost. The process first determines whether the total CPU system cost is greater than or equal to a threshold set by a maximum system cost parameter (block 501). If the total system cost is getting too high, then the maximum system cost parameter is reduced at block of 502, and the algorithm ends at block 503. In this way, in the next cycle through the run engine, a lower maximum system cost parameter is utilized causing the total number of resources to be implemented to fall. If at block 501, the total system cost is not greater than the threshold, then the process determines whether a delay parameter has expired since the last time the maximum system cost parameter was reduced (block 504). If the delay parameter has expired, then the default maximum system cost parameter is restored at block 505, and the process ends at block 503. If the delay parameter at block 504 has not expired, then the process ends at block 503, allowing the engine to continue to operate with the reduced maximum system cost parameter until the delay expires. This delay parameter causes hysteresis in the routine that changes the maximum system cost parameter.

Thus, if the usage ever exceeds a specific threshold (some high percentage of the overall maximum available CPU cycles), then the algorithm will
1. request that the voice allocator steal some cost to reduce the sounding system cost. The voice allocator will steal, according to the regular age/priority order, until it has freed quads of voice models, whose total quad costs add up to, or exceed, the requested cost.
2. lower the voice allocator's overall system max cost by a small percentage, for a period of time, to ensure a “recovery” period, during which the sounding cost will be kept slightly lower than usual The max cost will be raised again over some time until it is restored to its original value.

The system overage algorithm also maintains a long term running average of the overall per-tick system CPU cost. When this long-term average exceeds a high threshold, steps 1 and 2 will happen above, and the max cost will not be raised again until the long term average has been reduced below a low threshold. E.g. the default threshold might be 95% of the CPU and the low threshold might be 85%.

For short-term overage spikes, steps 1 and 2 will happen above, and the max cost will be raised by a small amount every tick, for several ticks, until the voice allocator's max cost is restored. For long-term overages, the maximum cost will be lowered for a longer period of time, allowing the system to recover.

A sound generating device is described which uses a general purpose processor to compute multiple voice generating algorithms in which each algorithm simultaneously calculates multiple voices using vector processing in response to performance information. A voice allocator module manages existing and new voices in algorithm-specific vector groups so that the limits of processing resources and memory are not exceeded. When a new performance event is requested, the overall resource impact, or cost, of the new event is determined and added to the current total cost. If these requirements exceed the system limits, existing resources are stolen using a hierarchical priority system to make room for the new event. Additionally, the cost impact of multiple voices started by a single event is amortized across multiple processing frames, to avoid excessive cost impact in any single frame. A means is provided to ensure that certain voices start together on the same tick for phase accuracy. A mechanism is included to continuously defragment the vectorized voice data to ensure that only the minimum number of vectors are processed at any time.

The voice allocation described herein is applied in a unique music synthesizer, which utilizes state of the art SIMD processors, or other vector processor based architectures.

Embodiments of the technology described herein include computer programs stored on magnetic media or other machine readable data storage media executable to perform functions described herein.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. For an audio processor that produces a plurality of voices by voice generation algorithms, a method for dynamically allocating voices to processor resources while executing a plurality of currently executing voices, comprising:
utilizing processor resources of the audio processor to execute voice generation algorithms for sounding voices, including at least one instance of a vector-based voice generation algorithm, said at least one instance of a vector-based voice generation algorithm being configurable to generate N voices, where N is an integer greater than 1;
identifying a new voice to be executed in response to an event; and
determining processor resources needed to be allocated for the new voice and the sounding voices, wherein said determining includes resolving whether the new voice can be generated by the at least one instance; and
if the processor resources are available to meet the needed processor resources, then allocating processor resources to a voice generation algorithm for the new voice, and if processor resources are not available, then de-allocating processor resources allocated to at least one sounding voice.

2. The method of claim 1, including after said de-allocating, repeating said determining.

3. The method of claim 1, including maintaining a start queue and a delay queue, and said allocating includes adding the new voice to the start queue, and if processor resources are not available, then adding the new voice to the delay queue and moving the new voice from the delay queue to the start queue after a delay.

4. The method of claim 1, wherein said at least one instance comprises a single instruction, multiple data SIMD thread.

5. The method of claim 1, wherein said identifying includes identifying a voice cluster including the new voice, and said determining includes determining whether processor resources are available for the voice cluster.

6. The method of claim 1, wherein said identifying includes identifying a voice cluster including the new voice, said determining includes determining whether processor resources are available for the voice cluster, and said de-allocating includes de-allocating processor resources allocated to a sounding cluster of voices including said at least one sounding voice.

7. The method of claim 1, wherein said processor resources include a plurality of instances of a particular vector-based voice generation algorithm executing a plurality of voices, where each instance in the plurality of instances is configurable to execute N voices of the plurality of voices, and including, if said de-allocating frees the sounding voice from one of the plurality of instances, then reconfiguring the plurality of instances so that at most one of the plurality of instances is configured to execute less than N voices.

8. The method of claim 1, wherein said at least one instance is configurable to execute N voices, and if said new voice is executable by said at least one instance, and said at least one instance is configured to execute less than N voices, then allocating said new voice to said at least one instance.

9. The method of claim 1, including assigning a resources cost parameter to voices to which processor resources can be allocated, assigning a maximum processor resources parameter and computing an allocated processor resources parameter indicating resources allocated to sounding voices and effects, and wherein said determining includes determining whether a combination of the allocated processor resources parameter with the resources cost parameter for the new voice exceeds the maximum processor resources parameter.

10. The method of claim 9, including changing the maximum processor resources parameter in response to a measure of allocation of processor resources.

11. The method of claim 1, wherein said identifying includes identifying a voice cluster including the new voice, said determining includes determining whether processor resources are available for the voice cluster, and including assigning a resources cost parameter to voices to which processor resources can be allocated, computing a maximum processor resources parameter and an allocated processor resources parameter, and wherein said determining includes determining whether a combination of the allocated processor resources parameter with the resources cost parameter for the voice cluster exceeds the maximum processor resources parameter.

12. The method of claim 11, including changing the maximum processor resources parameter in response to a measure of allocation of processor resources.

13. The method of claim 1, wherein said identifying includes identifying a voice cluster including the new voice, and including assigning a resources cost parameter to voices to which processor resources can be allocated, computing a maximum processor resources parameter, and if a combination of the resource cost parameters for the voice cluster exceeds the maximum processor resources parameter, then removing voices from the voice cluster.

14. The method of claim 11, including changing the maximum processor resources parameter in response to a measure of allocation of processor resources.

15. The method of claim 1, wherein said vector-based voice generation algorithm comprises a PCM voice model algorithm arranged for a SIMD processor.

16. The method of claim 1, wherein said vector-based voice generation algorithm comprises an analog voice model algorithm arranged for a SIMD processor.

17. An audio processor that produces a plurality of voices by voice generation algorithms, comprising:
a data processor including processor resources to execute voice generation algorithms for sounding voices, including at least one instance of a vector voice generation algorithm, said at least one instance of a vector-based voice generation algorithm being configurable to generate N voices, where N is an integer greater than 1; and
a voice allocation resource, the voice allocation resource including logic to identify a new voice to be executed in response to an event, and
determine processor resources needed to be allocated for the new voice and the sounding voices, including resolving whether the new voice can be generated by the at least one instance; and
if the processor resources are available to meet the needed processor resources, then allocate processor resources to a voice generation algorithm for the selected voice, and if processor resources are not available, then de-allocate processor resources allocated to at least one sounding voice.

18. The processor of claim 17, wherein said logic repeats said determine step after said de-allocate step.

19. The processor of claim 17, including logic to maintain a start queue and a delay queue, and said allocate step includes adding the selected voice to the start queue, and if processor resources are not available, then adding the selected voice to the delay queue and moving the selected voice from the delay queue to the start queue after a delay.

20. The processor of claim 17, wherein said processor comprises a single instruction, multiple data SIMD processor.

21. The processor of claim 17, wherein said identify step includes identifying a voice cluster including the new voice, and said determine step includes determining whether processor resources are available for the voice cluster.

22. The processor of claim 17, wherein said identify step includes identifying a voice cluster including the new voice, said determine step includes determining whether processor resources are available for the voice cluster, and said de-allocate step includes de-allocating processor resources allocated to a sounding cluster of voices including said at least one sounding voice.

23. The processor of claim 17, wherein said processor resources include a plurality of instances of a particular vector-based voice generation algorithm executing a plurality of voices, where each instance in the plurality of instances is configurable to execute N voices of the plurality of voices, and including logic which, if said de-allocate step frees the sounding voice from one of the plurality of instances, reconfigures the plurality of instances so that at most one of the plurality of instances is configured to execute less than N voices.

24. The processor of claim 17, wherein said at least one instance is configurable to execute N voices, and if said new voice is executable by said at least one instance, and said at least one instance is configured to execute less than N voices, then the allocate step allocates said new voice to said at least one instance.

25. The processor of claim 17, including logic to assign a resources cost parameter to voices to which processor resources can be allocated, to assign a maximum processor resources parameter and to compute an allocated processor resources parameter indicating resources allocated to sounding voices and effects, and wherein said determine step includes determining whether a combination of the allocated processor resources parameter with the resources cost parameter for the new voice exceeds the maximum processor resources parameter.

26. The processor of claim 25, including logic to change the maximum processor resources parameter in response to a measure of allocation of processor resources.

27. The processor of claim 17, wherein said identify step includes identifying a voice cluster including the new voice, said determining includes determining whether processor resources are available for the voice cluster, and including logic to assign a resources cost parameter to voices to which processor resources can be allocated, to assign a maximum processor resources parameter and to compute an allocated processor resources parameter, and wherein said determining step includes determining whether a combination of the allocated processor resources parameter with the resources cost parameter for the voice cluster exceeds the maximum processor resources parameter.

28. The processor of claim 27, including logic to change the maximum processor resources parameter in response to a measure of allocation of processor resources.

29. The processor of claim 17, wherein said identify step includes identifying a voice cluster including the new voice, and including logic to assign a resources cost parameter to voices to which processor resources can be allocated, and to assign a maximum processor resources parameter, and if a combination of the resources cost parameters for the voice cluster exceeds the maximum processor resources parameter, then to remove voices from the voice cluster.

30. The processor of claim 29, including logic to change the maximum processor resources parameter in response to a measure of allocation of processor resources.

31. The processor of claim 17, wherein said vector-based voice generation algorithm comprises a PCM voice model algorithm arranged for a SIMD processor.

32. The processor of claim 17, wherein said vector-based voice generation algorithm comprises an analog voice model algorithm arranged for a SIMD processor.

33. An article of manufacture, comprising:
a machine readable data storage medium storing computer programs executable by a data processor including processor resources to execute vector-based voice generation algorithms, the vector-based voice generation algorithms being configurable to generate N voices, where N is an integer greater than 1; the computer programs including
one or more voice generation algorithms for sounding voices;
logic to identify a new voice to be executed in response to an event;
determine processor resources needed to be allocated for the new voice and the sounding voices, including resolving whether the new voice can be generated by the at least one instance;
if the processor resources are available to meet the needed processor resources, then allocate processor resources to a voice generation algorithm for the selected voice, and if processor resources are not available, then de-allocate processor resources allocated to at least one sounding voice; and
logic to repeat said determine step after said de-allocate step.

34. The article of claim 33, wherein the computer programs include logic to maintain a start queue and a delay queue, and said allocate step includes adding the selected voice to the start queue, and if processor resources are not available, then adding the selected voice to the delay queue and moving the selected voice from the delay queue to the start queue after a delay.

35. The article of claim 33, wherein said identify step includes identifying a voice cluster including the new voice, and said determine step includes determining whether processor resources are available for the voice cluster.

36. For an audio processor that produces a plurality of voices by voice generation algorithms, a method for dynamically allocating voices to processor resources while executing a plurality of currently executing voices, comprising:
utilizing processor resources of the audio processor to execute voice generation algorithms for sounding voices;
assigning a resources cost parameter to respective voices to which processor resources can be allocated;
assigning a maximum processor resources parameter;
identifying a new voice to be executed in response to an event; and
determining an allocated processor resources parameter indicating resources allocated to sounding voice and effects, and determining whether a combined cost of the allocated processor resources parameter with the resources cost parameter for the new voice exceeds the maximum processor resources parameter;
if the combined cost does not exceed the maximum processor resource parameter, then allocating processor resources to a voice generation algorithm for the new voice, and if combined cost exceeds the maximum processor resource parameter, then de-allocating processor resources allocated to at least one sounding voice; and
changing the maximum processor resources parameter in response to a measure of allocation of processor resources.
